(19) United States
(12) Patent Application Publication
(10) Pub. No.: US 2007/0115817 A1
(43) Pub. Date: May 24, 2007

(54) MINIMUM RATE GUARANTEES ON WIRELESS CHANNEL USING RESOURCE UTILIZATION MESSAGES

(75) Inventors: Rajarshi Gupta, San Diego, CA (US); Ashwin Sampath, San Diego, CA (US); David Jonathan Julian, San Diego, CA (US); Gavin Horn, La Jolla, CA (US); Nikhil Jain, Mendham, NJ (US); Rajat Prakash, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 11/553,423

(22) Filed: Oct. 26, 2006

Related U.S. Application Data
(60) Provisional application No. 60/730,627, filed on Oct. 26, 2005.

(51) Int. Cl. H04L 12/26

(52) U.S. Cl. 370/230; 370/468

(57) ABSTRACT

Systems and methods are described that facilitate performing interference management techniques between sending and receiving nodes in order to provide minimum transmission rate guarantees. Carrier-to-interference ratio (C/I) may be controlled by employing specialized resource utilization messages (RUMs), the number and rate of which may be governed by a “token bucket” mechanism. For instance, a maximum token bucket size may be defined for a node, which describes the maximum amount of data that may pass through the node at a given time. A current number of tokens in the node's bucket may be evaluated and compared to a threshold value, and RUMs may be transmitted by the node as long as the current token number is greater than the predefined threshold value. Tokens may additionally be deducted from the node's bucket for successful data transmissions, thus providing a dynamic interference control mechanism.

### CROSS-REFERENCE

This application claims the benefit of U.S. Provisional Application Ser. No. 60/730,627, entitled “MINIMUM RATE GUARANTEES ON WIRELESS CHANNELS USING RESOURCE UTILIZATION MASKS,” filed on Oct. 26, 2005, the entirety of which is incorporated herein by reference.

### BACKGROUND

I. Field

The following description relates generally to wireless communications, and more particularly to reducing interference in a wireless communication environment.

II. Background

Wireless communication systems have become a prevalent means by which a majority of people worldwide has come to communicate. Wireless communication devices have become smaller and more powerful in order to meet consumer needs and to improve portability and convenience. The increase in processing power in mobile devices such as cellular telephones has lead to an increase in demands on wireless network transmission systems.

More particularly, frequency division based techniques typically separate the spectrum into distinct channels by splitting it into uniform chunks of bandwidth, for example, division of the frequency band allocated for wireless communication can be split into 30 channels, each of which can carry a voice conversation or, with digital service, carry digital data. Each channel can be assigned to only one user at a time. One known variant is an orthogonal frequency division technique that effectively partitions the overall system bandwidth into multiple orthogonal sub bands. These subbands are also referred to as tones, carriers, subcarriers, bins, and/or frequency channels. Each subband is associated with a subcarrier that can be modulated with data. With time division based techniques, a band is split time-wise into sequential time slices or time slots. Each user of a channel is provided with a time slice for transmitting and receiving information in a round-robin manner. For example, at any given time t, a user is provided access to the channel for a short burst. Then, access switches to another user who is provided with a short burst of time for transmitting and receiving information. The cycle of “taking turns” continues, and eventually each user is provided with multiple transmission and reception bursts.

Code division based techniques typically transmit data over a number of frequencies available at any time in a range. In general, data is digitized and spread over available bandwidth, wherein multiple users can be overlaid on the channel and respective users can be assigned a unique sequence code. Users can transmit in the same wide-band chunk of spectrum, wherein each user's signal is spread over the entire bandwidth by its respective unique spreading code. This technique can provide for sharing, wherein one or more users can concurrently transmit and receive. Such sharing can be achieved through spread spectrum digital modulation, wherein a user's stream of bits is encoded and spread across a very wide channel in a pseudo random fashion. The receiver is designed to recognize the associated unique sequence code and undo the randomization in order to collect the bits for a particular user in a coherent manner.

A typical wireless communication network (e.g., employing frequency time, and code division techniques) includes one or more base stations that provide a coverage area and one or more mobile (e.g. wireless) terminals that can transmit and receive data within the coverage area. A typical base station can simultaneously transmit multiple data streams for broadcast, multicast, and/or unicast services, wherein a data stream is a stream of data that can be of independent reception interest to a mobile terminal. A mobile terminal within the coverage area of that base station can be interested in receiving one, more than one or all the data streams carried by the composite stream. Likewise, a mobile terminal can transmit data to the base station or another mobile terminal. Such communication between base station and mobile terminal or between mobile terminals can be degraded due to channel variations and/or interference power variations. Accordingly, a need in the art exists for systems and/or methodologies that facilitate reducing interference and improving throughput in a wireless communication environment.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with various aspects, minimum transmission rate guarantees may be provided through interference management techniques between a sending node and a receiving node. To control carrier-to-interference ratios (C/I), special broadcast messages called receiver resource utilization messages (RxRUMs) may be transmitted by a receiver. The rate and quantity of RxRUM transmission may be controlled by a “token bucket” mechanism at the receiver. During periods of congestion, nodes may share channels fairly according to a ratio that defines their respective token bucket rates. At other times, excess traffic may be apportioned differently to enhance sector throughput.

According to an aspect, a method of facilitating data transmission, may comprise assigning tokens to a node as a function of a token rate associated with the node, determining whether a number of tokens assigned to the node is equal to or greater than a predefined minimum number of tokens, and transmitting at least one resource utilization message (RUM) based on the determination.

According to another aspect, an apparatus that facilitates data transmission may comprise a token module that assigns tokens to a node as a function of a token rate associated with the node and determines whether a number of tokens assigned to the node is equal to or greater than a predefined minimum number of tokens, and a transmitter that transmits at least one resource utilization message (RUM) based on the determination.

According to another aspect, an apparatus that facilitates data transmission may comprise means for assigning tokens to a node as a function of a token rate associated with the node, means for determining whether a number of tokens assigned to the node is equal to or greater than a predefined minimum number of tokens, and means for transmitting at least one resource utilization message (RUM) if the number of tokens based on the determination.

Yet another aspect relates to a machine-readable medium comprising instructions for data transmission, wherein the instructions upon execution cause the machine to assign tokens to a node as a function of a token rate associated with the node, determine whether a number of tokens assigned to the node is equal to or greater than a predefined minimum number of tokens, and transmit at least one resource utilization message (RUM) based on the determination.

Another aspect relates to a processor for facilitating data transmission, the processor being configured to assign tokens to the node as a function of the token rate, determine whether a number of tokens assigned to the node is equal to or greater than a predefined minimum number of tokens, and transmit at least one resource utilization message (RUM) based on the determination.

To the accomplishment of the foregoing and related ends, the one or more aspects comprise the features hereinafter fully described and particularly pointed out in the claims. The following description and the annexed drawings set forth in detail certain illustrative aspects of the one of more aspects. These aspects are indicative, however, of but a few of the various ways in which the principles of various aspects may be employed and the described aspects are intended to include all such aspects and their equivalents.

### BRIEF DESCRIPTION OF THE DRAWINGS

FIG. 1 is an illustration of an ad hoc, or random, wireless communication environment 100, in accordance with various aspects.

FIG. 2 is an illustration of several topologies that facilitate understanding of token-based RUM schemes, in accordance with various aspects.

FIG. 3 illustrates a sequence of request-grant events that can facilitate resource allocation, in accordance with one or more aspects described herein.

FIG. 4 is an illustration of a method for performing a request-grant protocol in order to provide context for the token mechanism and to facilitate achieving efficient spatial reuse, in accordance with various aspects described herein.

FIG. 5 is an illustration of a method for determining whether to transmit an RxRUM upon detection of a minimum token condition, in accordance with one or more aspects.

FIG. 6 is an illustration of a methodology for guaranteeing a minimum rate on wireless channels using resource utilization messages (RUMs), in accordance with various aspects.

FIG. 7 is an illustration of an access terminal that facilitates providing minimum rate guarantees using resource utilization messages, in accordance with one or more aspects.

FIG. 8 is an illustration of a system that facilitates minimum transmission rate guarantees using resource utilization messages, in accordance with one or more aspects.

FIG. 9 is an illustration of a wireless network environment that can be employed in conjunction with the various systems and methods described herein.

FIG. 10 is an illustration of an apparatus that facilitates guaranteeing a minimum transmission rate on wireless channels by employing resource utilization messages (RUMs) in accordance with various aspects.

### DETAILED DESCRIPTION

Various aspects are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

As used in this application, the terms “component,” “system,” and the like are intended to refer to a computer-related entity, either hardware, software, software in execution, firmware, middle ware, microcode, and/or any combination thereof. For example, a component may be, but is not limited to being, a process running on a processor, a processor, an object, an executable, a thread of execution, a program, and/or a computer. One or more components may reside within a process and/or thread of execution and a component may be localized on one computer and/or distributed between two or more computers. Also, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal). Additionally, components of systems described herein may be rearranged and/or complimented by additional components in order to facilitate achieving the various aspects, goals, advantages, etc., described with regard thereto, and are not limited to the precise configurations set forth in a given figure, as will be appreciated by one skilled in the art.

Furthermore, various aspects are described herein in connection with a subscriber station. A subscriber station can also be called a system, a subscriber unit, mobile station, mobile, remote station, remote terminal, access terminal, user terminal, user agent, a user device, or user equipment. A subscriber station may be a cellullar telephone, a cordless telephone, a Session Initiation Protocol (SIP) phone, a wireless local loop (WLL) station, a personal digital assistant (PDA), a handheld device having wireless connection capability, or other processing device connected to a wireless modem.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic, storage devices (e.g., hard disk, floppy disk, magnetic strips . . . ), optical disks (e.g., compact disk (CD), digital versatile disk (DVD). . . ), smart cards, and flash memory devices (e.g., card, stick, key drive . . . ). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. It will be appreciated that the word “exemplary” is used herein to mean “serving as an example, instance, or illustration.” Any aspect or design described herein as “exemplary” is not necessarily to be construed as preferred or advantageous over other aspects or designs.

According to various aspects, request messages, grant messages, and transmissions many be power controlled: however, a node may nonetheless experience excessive interference that causes its signal-to-interference noise (SINR) levels to be unacceptable. In order to mitigate undesirably low SINR, resource utilization messages (RUMs) may be utilized, which can be receiver-side (RxRUM) and/or transmitter-side (TxRTM) An RxRUM may be broadcast by a receiver when interference levels on the receiver's desired channels exceed a predetermined threshold level. The RxRUM may contain a list of granted channels upon which the receiver desires reduced interference, as well as node weight information. Nodes (e.g., transmitters) hearing the RxRUM will reduce the interference they cause by stopping the transmission, or by reducing the power of the transmission so as to reduce the interference caused at the receiver. The weight of a given node may be utilized to calculate the fair share of resources for allocation to the node.

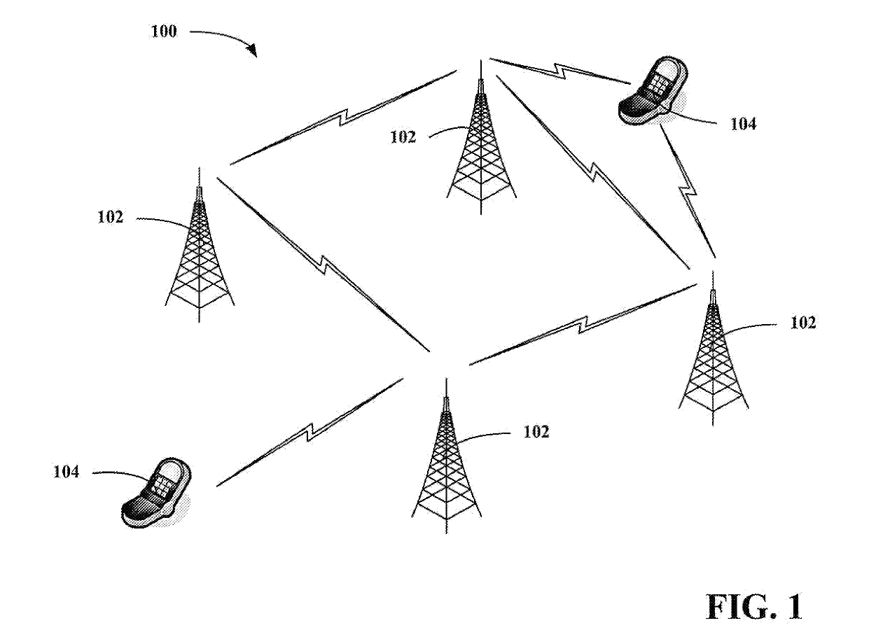

FIG. 1 is an illustration of an ad hoc, or random, wireless communication environment 100, in accordance with various aspects. System 100 may comprise one or more access points 102, which may be fixed, mobile, radio, Wi-Fi, etc., in one or more sectors that receive, transmit, repeat, etc., wireless communication signals to each other and/or to one or more access terminals 104. Each access point 102 may comprise a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art. Access terminals 104 may be, for example, cellular phones, smart phones, laptops, personal computers, handheld communication devices, handheld computing devices, satellite radios, global positioning systems, PDAs, and/or any other suitable device for communicating over wireless network 100. System 100 can be employed in conjunction with various aspects described herein order facilitate providing scalable resource reuse in a wireless communication environment, as set forth with reward to subsequent figures.

Access terminals 104 are typically dispersed throughout the system, and each terminal may be fixed or mobile. An access terminal may also be called a mobile device, a mobile station, user equipment, a user device, or some other terminology. A terminal may be a wireless device, a cellular phone, a personal digital assistant (PDA), a wireless modem card, and so on. Each access terminal 104 may communicate with zero, one, or multiple base stations on the downlink and uplink at any given moment. The downlink (or forward link) refers to the communication link from the base stations to the terminals, and the uplink (or reverse link) refers to the communication link from the terminals to the base stations.

In an ad hoc architecture, access points 102 may communicate with one another as needed. Data transmission on the forward link may occur from one access point to one access terminal at or near the maximum data rate that can be supported by the forward link and/or the communication system. Additional channels of the forward link may be transmitted from multiple access points to one access terminal. Reverse link data communication may occur from one access terminal to one or more access points.

According to other aspects, excess bandwidth may be allocated according to a sharing scheme that is unfettered with regard to the above constraints. For instance, weight-based scheduling, whereby nodes may receive transmission rate assignments in a ratio of their respective weights, etc., can facilitate weighed fair-sharing of resources. However, in a case where excess bandwidth is present, allocation of resources (e.g., above the minimum fair share, . . . ), need not be constrained. For instance, a scenario may be considered wherein two nodes (e.g., access points, access terminals, or a combination thereof) with full buffers each have weights of 100 (e.g., corresponding to flow rates of 100 kbps), and are sharing a channel. In this situation, the nodes can share the channel equally. If they experienced varying channel qualities, each of the two nodes may be granted, for example, 300 kbps. However, it maybe desirable to give only 200 kbps to node 1, in order to increase node 2's share to 500 kbps. That is, in such situations, it may be desirable to share any excess bandwidth in some unfair fashion, in order to achieve greater sector throughput. The token mechanism facilitates this by limiting a maximum number of RUMs that may be sent by a node. For example, each node may ensure a predefined bit rate (e.g., 100 kbps, or some other predefined bit rate) using RUMs, and excess bandwidth may be apportioned in a sector-throughput optimizing fashion.

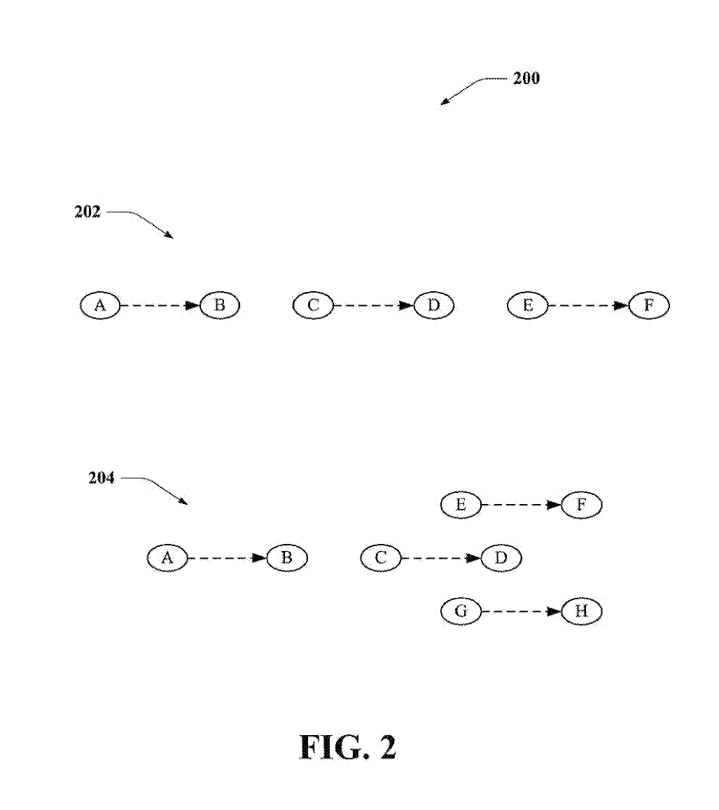

FIG. 2 is an illustration of topologies that facilitate understanding of token-based RUM schemes, in accordance with various aspects. The first topology 202 has three links in a chain, and the middle link (C-D) interferes with both outer links (A-B and E-F), while the outer links do not interfere with each other. The RUMs may be simulated, according to this example, such that the range of a RUM is two nodes. For instance, a RUM from node C may be heard by nodes A and B, as well as by nodes D and E. The second topology 204 comprises three links on the right hand side (C-D, E-F, and G-H) that interfere with each other and can hear each other's RUMs. The single link (A-B) on the left side only interferes with the link (C-D).

Table 1 shows several exemplary results from topology 202, wherein the left-most column describes qualitatively the rate at which tokens are filled into a node's bucket, and wherein the token rate column expresses the actual rate at which tokens may be added to each node. In other words, the comments on the left indicate the token rate, relative to the possible fair share for the link. The numbers on links AB, CD and EF indicate the final throughput received on these links.

TABLE 1

| | Token Rate of | | | |
|---|---|---|---|---|
| Topology 2 | all three links | AB | CD | EF |
| Too Many | 1 | 0.75 | 0.20 | 0.47 |
| Too Many | 2/3 | 0.66 | 0.29 | 0.48 |
| Optimal | 1/2 | 0.50 | 0.49 | 0.50 |
| Too Few | 1/3 | 0.55 | 0.44 | 0.44 |
| Too Few | 1/4 | 0.60 | 0.39 | 0.60 |
| Too Few | 1/6 | 0.66 | 0.33 | 0.66 |

As seen from the table, the system can function according to one of three regimes, depending on the rate of token generation. For instance, if the token rate for the nodes is too high, there is an excess of tokens available, and all nodes can send RxRUMs at any time. As a result a link in the middle of the network may receive an unfairly low share of the resources, and the tokens lose their intrinsic value. If the token rate is optimal, the links share the channel fairly. Finally, if the token rate is too low, the rate of sending RUMs may be limited by the availability of the tokens. The tokens ensure the “guaranteed” share, but the excess many be shared in an unconstrained manner. According to the example, as the token rate goes lower (e.g. to ⅙) the throughput achieved by CD falls, although remaining above the token rate.

Table 2 is illustrative of an example related to topology 204. As will be understood, the excess bandwidth on the left, unused by link CD (due to contention from links EF and GH) is picked up by AB, thereby maintaining high sector throughput. According to an aspect, the token rate (guaranteed) to each node may be kept in the “too-few” regime, which constraint may be enforced by a higher-layer admission control mechanism that can ensure that, for instance, high priority voice/video calls get the desired throughput that they need. In such cases, the excess bandwidth may be apportioned unfairly, yet such may be desirable since it will lead to higher sector throughput.

TABLE 2

| | Token Rate | | | | |
|---|---|---|---|---|---|
| | of all four | | | | |
| Topology 3 | links | AB | CD | EF | GH |
| Too Many | 1 | 0.75 | 0.19 | 0.23 | 0.22 |
| Too Many | 2/3 | 0.66 | 0.26 | 0.24 | 0.23 |
| Too Many | 1/2 | 0.63 | 0.32 | 0.23 | 0.23 |
| Just Right | 1/3 | 0.66 | 0.33 | 0.33 | 0.33 |
| Too Few | 1/4 | 0.67 | 0.32 | 0.33 | 0.33 |
| Too Few | 1/6 | 0.69 | 0.31 | 0.33 | 0.35 |
| Too Few | 1/10 | 0.73 | 0.27 | 0.38 | 0.35 |

In another aspect of the innovation, the excess bandwidth may be shared in a fairer manner, using virtual tokens. According to an example three contending nodes may each have a token rate of 2/10. The nodes are all sending data to the same AP, which is aware of the token rates of the nodes. Over a period of time, the three nodes achieve rates of 4/10, 4/10 and 2/10, respectively, which can indicate to the AP that node 3 is not getting more than its token share, although excess bandwidth is available. The AP can indicate such to node 3, which may then try to increase its share using virtual tokens. For example while tokens may be added to a node's token bucket as a function of the token rate assigned to the node by the network (e.g., a network controller or the like), the node may add virtual tokens to its own bucket to temporarily send out an increased number of RUMs. If this results in an improved throughput—the node may continue to transmit the increased number of RUMs until congestion increases. For other nodes hearing the RUMs, virtual RUMs may be predefined, to have a lower priority than real RUMs.

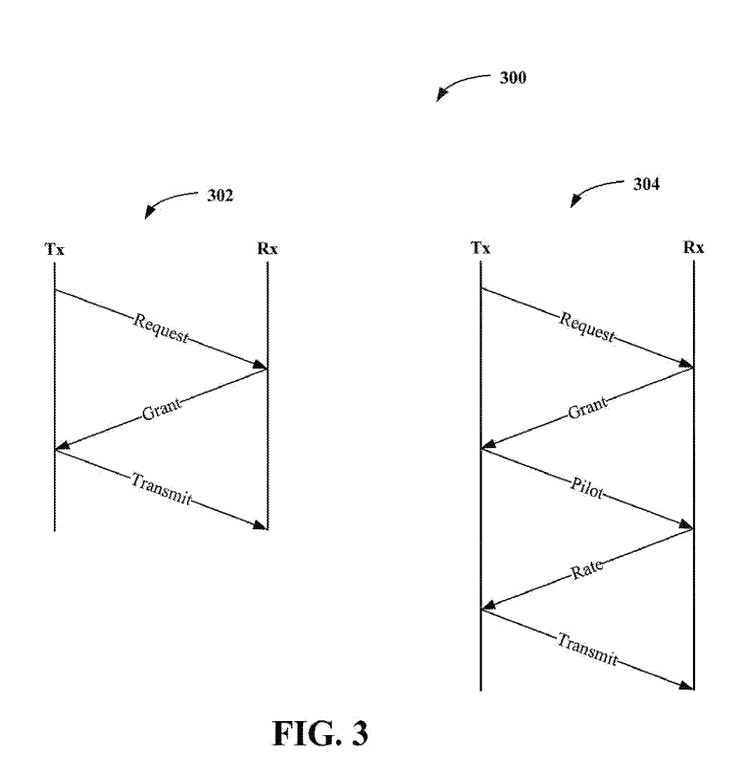

In order to provide some context regarding request and grant protocols, FIG. 3 illustrates a sequence of request-grant events that can facilitate resource allocation, in accordance with one or more aspects described herein. A first series of events 302 is depicted, comprising a request that is sent from a transmitter to a receiver. Upon receiving the request, the receiver may send a grant message to the transmitter, which grants all or a subset of channels requested by the transmitter. The transmitter may then transmit data over some or all of the granted channels.

According to a related aspect, a sequence of events 304 can comprise a request that is sent from a transmitter to a receiver. The request can include a list of channels over which the transmitter would like to transmit data to the receiver. The receiver may then send a grant message to the transmitter, which indicates all or a subset of the desired channels have been granted. The transmitter may then transmit a pilot message to the receiver, upon receipt of which the receiver may transmit rate information back to the transmitter, to facilitate mitigating an undesirably high SINR. Upon receipt of the rate information, the transmitter may proceed with data transmission over the granted channels and at the indicated transmission rate.

The sequence of events 302 and 304 may be performed in view of a plurality of constraints that may be enforced during a communication event. For example, the transmitter may request any channel(s) that have not been blocked by a RxRUM in a previous time slot. The requested channels may be prioritized with a preference for a successful channel in a most recent transmission cycle. In the event that there are insufficient channels, the transmitter may request additional channels to obtain a fair share thereof by sending TxRUMs to announce the contention for the additional channels. The fair share of channels can then be determined according to the number and weights of contending neighbors (e.g., nodes), in view of RxRUMs that have been heard.

The grant from the receiver may be a subset of the channels listed in the request. The receiver can be endowed with authority to avoid channels exhibiting high interference levels during a most recent transmission. In the event that the granted channels are insufficient, the receiver may add channels (e.g., up to the transmitter's fair share) by sending one or more RxRUMs. The transmitter's fair share of channels can be determined by, for instance, evaluating the number and weights of neighboring nodes, in view of TxRUMs that have been heard (e.g. received).

When transmitting, the transmitter may send data over the all or a subset of channels granted in the grant message. The transmitter may reduce transmission power on some or all channels upon hearing an RxRUM. In the event that the transmitter hears multiple grants and/or RxRUMs on a same channel, the transmitter may transmit with reciprocal probability. For instance, if three RxRUMs and one grant are heard for a single channel, then the transmitter may transmit with a probability of ⅓, etc, (e.g., the probability that the transmitter will employ the channel, is ⅓).

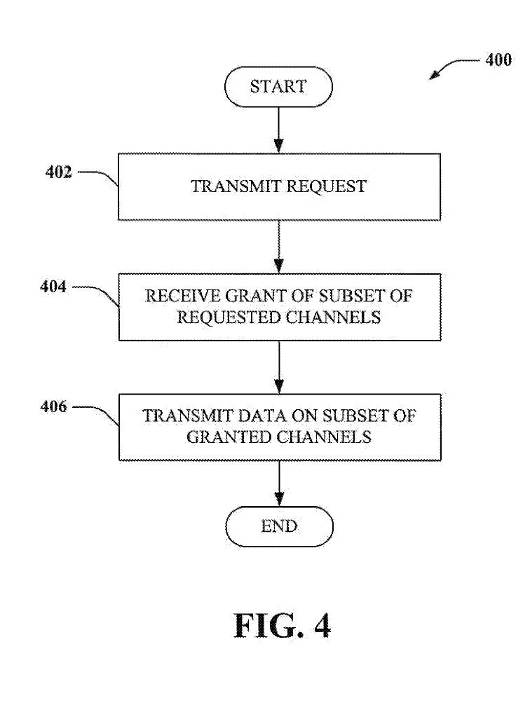

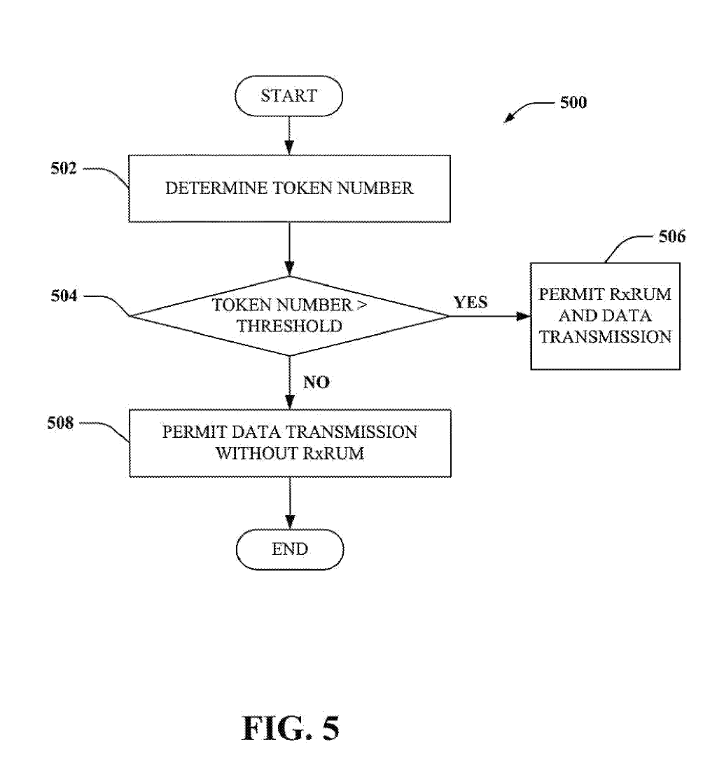

Referring to FIGS. 4-6, methodologies relating to providing minimum rate guarantees are illustrated. For example, methodologies can relate to providing minimum rate guarantees in an FDMA environment, an OFDMA environment, a CDMA environment, a WCDMA environment, a TDMA environment, an SDMA environment, or any other suitable wireless environment. While, for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

FIG. 4 is a illustration of a method 400 for performing a request-grant protocol in order to provide context for the token mechanism and to facilitate achieving efficient spatial reuse, in accordance with various aspects described herein. According to the method, at 402, a request for a set of channels may be transmitted from a transmitter at a first node (e.g., an access terminal, an access point, etc.) to a receiver at a second node. The request may comprise a bitmask of preferred channels over which the transmitter at the first node intends to transmit. The request may additionally be power controlled to ensure a desired level of reliability at the second node. At 404, a grant of a subset of the requested channel may be received at the first node. The grant message may also be power controlled to ensure a desired level of reliability at the first node. At 406, data may be transmitted on a subset of the granted channels. The data transmission may be power controlled to optimize spatial reuse of channels. Thus, the foregoing combination of events may be performed to facilitate providing transmission rate guarantees in an ad hoc communication environment by including both a transmitting node and a receiving node in scheduling decisions.

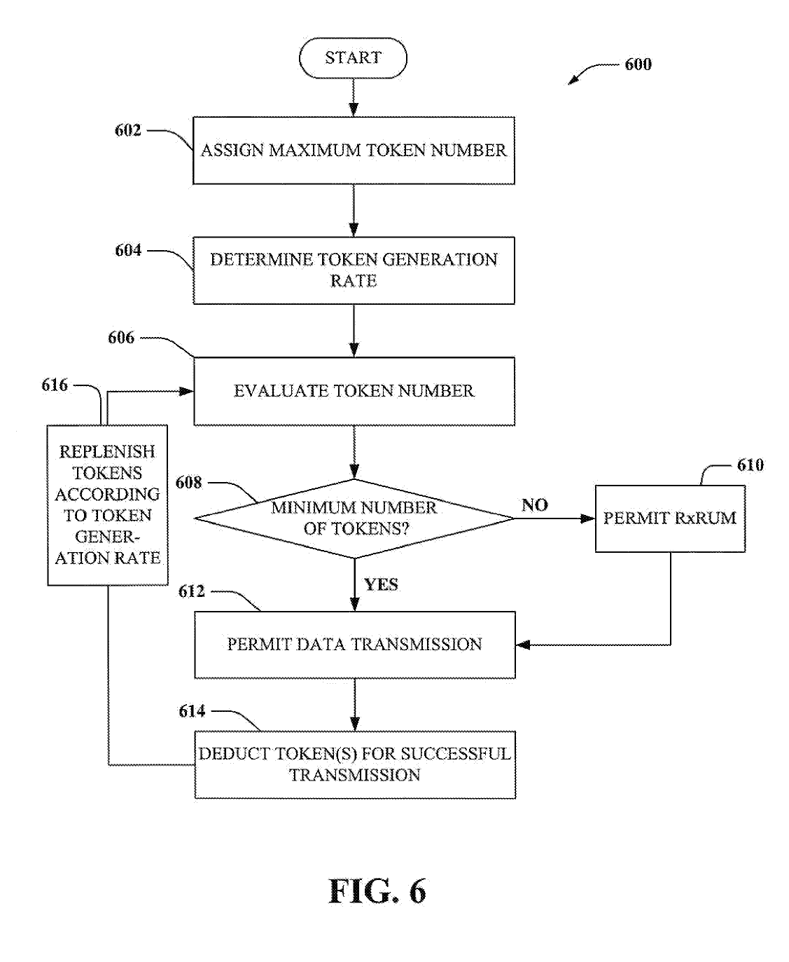

FIG. 6 is an illustration of a method 500 for determining whether to transmit an RxRUM upon detection of a minimum token condition, in accordance with one or more aspects. According to the method, at 502, a number of tokens associated with a node may be determined. The number of tokens may be a function of a token generation rate and a period of time during which tokens are generated, as well as token deductions for successful transmissions. At 504, a determination may be made regarding whether the token number for the node is greater than a minimum token threshold number. If the node has more than the minimum threshold number of tokens, and is facing undesirable SINR levels, then at 506, the node may be permitted to transmit an RxRUM in addition to transmitting data. If the node has a number of tokens less than or equal to the minimum threshold number of tokens, then at 508, the node may be permitted to transmit data without an RxRUM. This token bucket mechanism is described in greater detail below, with regard to FIG. 6.

FIG. 6 is an illustration of a methodology 600 for guaranteeing a minimum rate on wireless channels using resource utilization messages (RUMs), in accordance with various aspects. Methodology 600 facilitates providing minimum transmission rate guarantees to users while improving throughput by efficient spatial reuse, and may be employed in, for example, a synchronous ad hoc medium access control (MAC) or the like. For instance, a token mechanism may be employed to control the amount of RxRUM that a given node may send out. The token mechanism may limit a share of resources that the node may occupy during periods of congestion (e.g., periods of high activity in a wireless communication environment). To control carrier-to-interference ratio (C/I), RxRUMs may be transmitted by a receiver, while the rate ad quantity of such may be governed by a “token bucket” mechanism. During periods of congestion, nodes share resources fairly according to their respective token bucket rates, while at other times excess traffic may be apportioned differently to enhance sector throughput.

At 602, a maximum token number, which may represent a token “bucket” size, may be defined for and assigned to a node, which limits the amount of traffic that the node may burst on to the network. At 604, a token generation rate may be determined or assigned to the node according to a plurality of factors that may include, without being limited to node topology, node priority (e.g. weight, . . . ), a number and type of active flows through the node, etc. At 606, a number of tokens in the node's bucket may be evaluated. A determination may be made at 608 regarding whether the number of tokens in the node's bucket is greater than a minimum token threshold value, which may be zero or any other predefined minimum number (e.g., 1, 2, 6, . . . ). If the number of tokens in the node's bucket is greater than the minimum number, then the node may be permitted to generate and transmit an RxRUM if so required (e.g. if its SINR level is unsatisfactory) at 610. Sending the RxRUM allows the node to limit the interference it faces from its neighbors, and consequently the subsequent data transmission is more likely to succeed.

If the number of tokens in the node's bucket is less than or equal to the minimum threshold value, then at 612, data transmission may still be permitted but without the aid of an RxRUM. Upon a successful data transmission, a number of tokens proportional to the amount of data transmitted may be deducted from the node's bucket, at 614. At 616, tokens maybe replenished at a pace defined by the token generation rate. The method may then revert to 606 for further iteration. During periods of little or no congestion, nodes do not experience heavy interference and therefore do not need to transmit RxRUMs. Additionally, during such times, nodes may be permitted to utilize as many resources as needed. Tokens thus provide a mechanism for controlling resources during congestion, and, while they may be deducted from the bucket upon successful transmission(s) the bucket need only be emptied down to zero (e.g., the bucket has a non-negative value). Improved throughput and spatial reuse may thus be achieved between sending and receiving nodes.

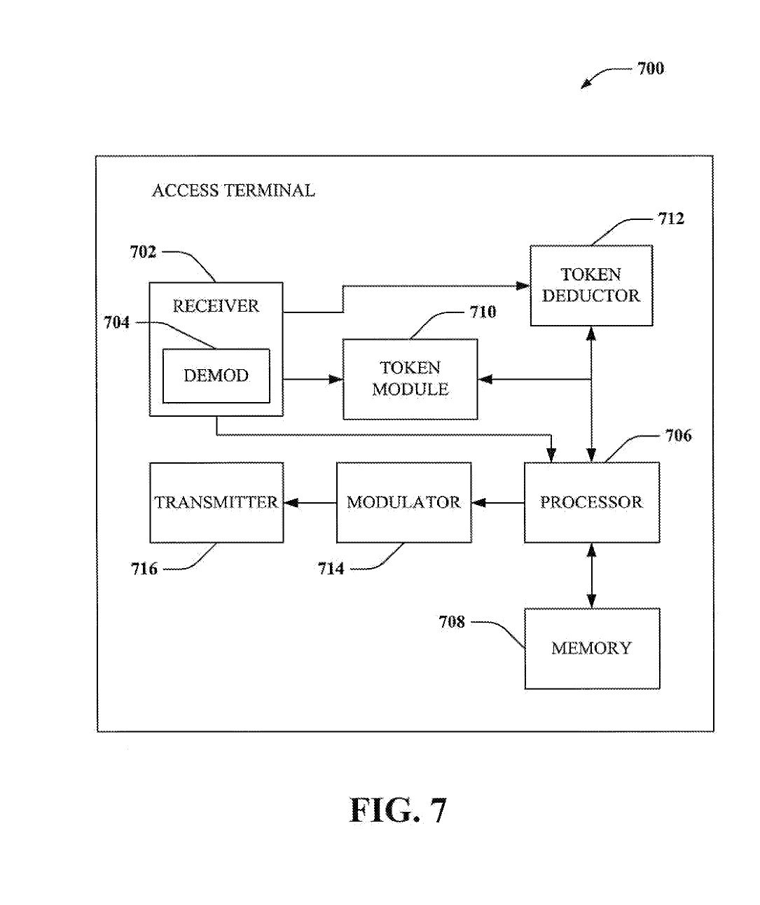

FIG. 7 is an illustration of an access terminal 700 that facilitates providing minimum rate guarantees using resource utilization messages, in accordance with one or more aspects. Access terminal 700 comprises a receiver 702 that receives a signal from, for instance a receive antenna (not shown), and performs typical actions thereon (e.g., filters, amplifies, downconverts, etc.) the received signal and digitizes the conditioned signal to obtain samples. Receiver 702 can comprise a demodulator 704 that can demodulate received, symbols and provide them to a processor 706 for channel estimation. Processor 706 can be a processor dedicated to analyzing information received by receiver 702 and/or generating information for transmission by a transmitter 716, a processor that controls one or more components of access terminal 700, and/or a processor that both analyzes information received by receiver 702, generates information for transmission by transmitter 716, and controls one or more components of access terminal 700. Additionally, processor 706 and/or token module 710 may execute instructions for evaluating token generation rate and/or token number for access terminal 700, for comparing token number to a minimum threshold value, for generating an RxRUM for transmission when token number is above the minimum threshold value, etc.

Access terminal 700 can additionally comprise memory 708 that is operatively coupled to processor 706 and that may store data to be transmitted, received data, and the like. Memory 708 may store information related to tokens in the access terminal's token store, or bucket, protocols for evaluating token number, protocols for comparing token number to a minimum token value, protocols for generating an RxRUM for transmission along with data when the token number is greater than the minimum threshold value, protocols for transmitting data without an RxRUM when the token number is at or below the minimum threshold token value, etc.

It will be appreciated that the data store (e.g., memory 708) described herein can be either volatile memory or nonvolatile memory, or can include both volatile and nonvolatile memory. By way of illustration, and not limitation, nonvolatile memory can include read only memory (EPROM), programmable ROM (PROM), electrically programmable ROM (EPROM, electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 708 of the subject systems and methods is intended to comprise, without being limited to, these and any other suitable types of memory.

Receiver 702 is further operatively coupled to token module 710, which may generate tokens according to an assigned token generation rate, as described above. A token deductor 712 may additionally deduct tokens for each successful transmission from access terminal 700. The number of token deducted may be a function of an amount of data successfully transmitted. In this manner, tokens may be dynamically adjusted for access terminal 700 based on successful transmissions, which are indicative of a level of interference experienced by access terminal 700. Thus, when interference increases, transmission success will be impeded, and fewer tokens will be deducted relative, to tokens being generated. This in turn will increase tokens in the access terminal's bucket, permitting RxRUMs to be generated and transmitted to interfering nodes in order to reduce interference to an acceptable level.

Access terminal 700 still further comprises a modulator 714 and a transmitter 716 that transmits the signal to, for instance, a base station, an access point, another access terminal, a remote agent, etc. Although depicted as being separate from the processor 706, it is to be appreciated that token module 710 and token deductor 712 may be part of processor 706 or a number of processors (not shown).

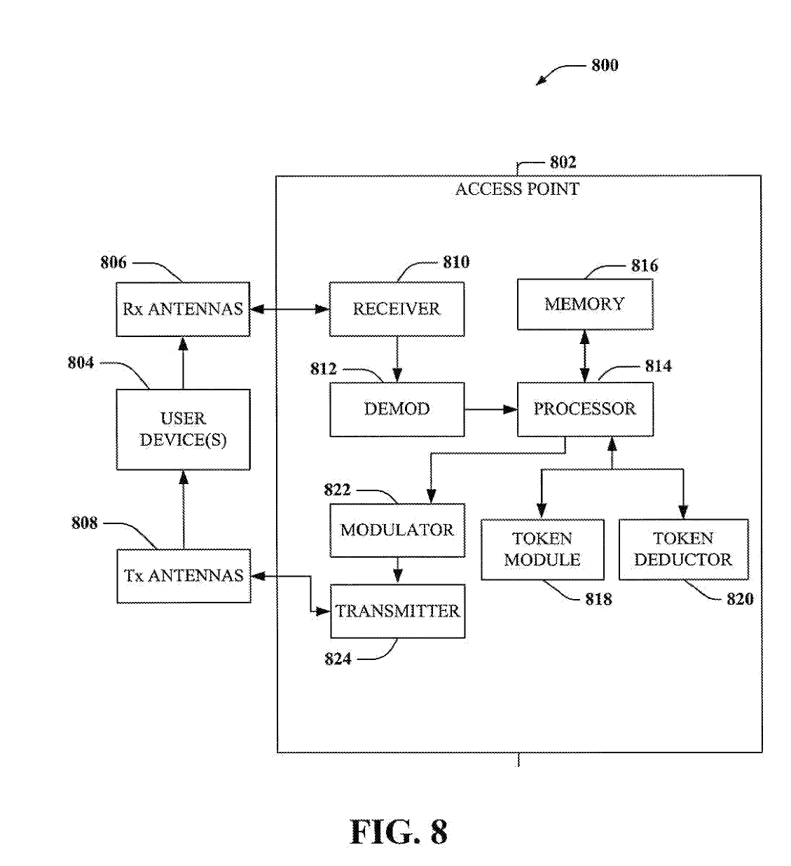

FIG. 8 is an illustration of a system 800 that facilitates minimum transmission rate guarantees using resource utilization messages, in accordance with one or more aspects. System 800 comprises an access point 802 with a receiver 810 that receives signal(s) from one or more user devices 804 through a plurality of receive antennas 806, and a transmitter 824 that transmits to the one or more user devices 804 through a transmit antenna 808. Receiver 810 can receive information from receive antennas 806 and is operatively associated with a demodulator 812 that demodulates received information. Demodulated symbols are analyzed by a processor 814 that can be similar to the processor described above with regard to FIG. 8, and which is coupled to a memory 816 that stores information related to token generation and deductions, token rate assignments, RxRUM generation and transmission, token maxima and minima, threshold levels, and/or any other suitable information related to performing the various actions and functions set forth herein.

Processor 814 may be further coupled to token module 818 and a token deductor 820, which may facilitate dynamically adjusting a token number for access point 802. Processor 814 and/or token module 818 may execute instructions similar to those described above with regard to processor 706 and/or token module 710. For example, token module 818 may generate tokens for access point 802 at a predefined rate, and such tokens may be stored in a virtual token “bucket” which may reside in memory 816. Upon successful transmission of data, token deductor 820 may deduct a number of tokens that is proportional to an amount of data transmitted in the successful transmission. Processor 814 may be further coupled to a modulator 822, which may multiplex signal information for transmission by a transmitter 824 through antenna 808 to user device(s) 804. Although depicted as being separate from processor 814, it is to be appreciated that token module 818, token deductor 820, and/or modulator 822 may be part of processor 814 or a number of processors (not shown).

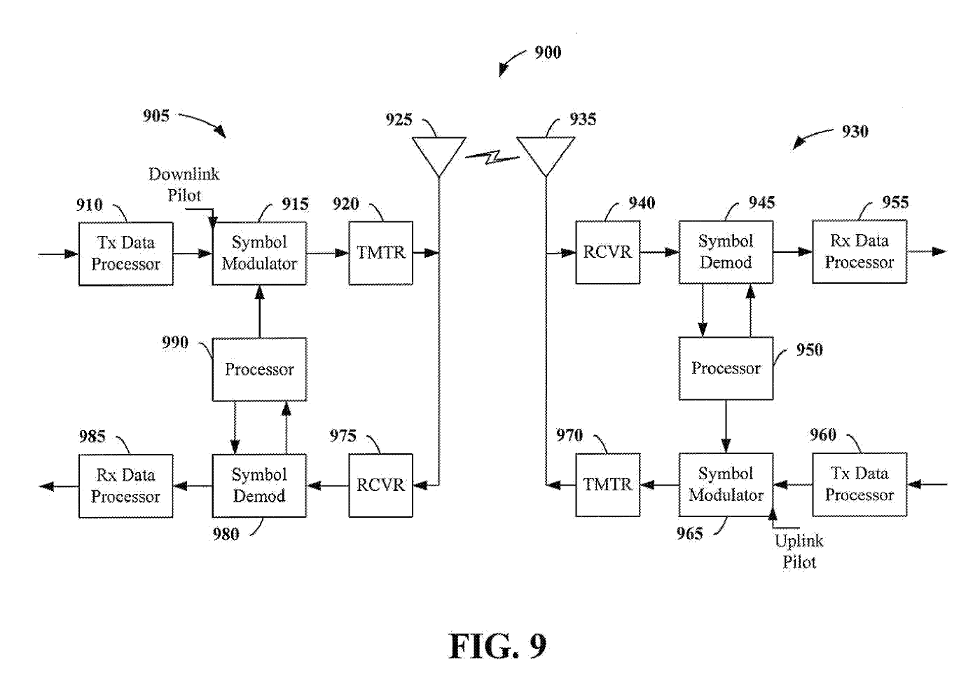

FIG. 9 shows an exemplary wireless communication system 900. The wireless communication system 900 depicts one access point and one terminal for sake of brevity. However, it is to be appreciated that the system can include more than one access point and/or more than one terminal, wherein additional access points and/or terminals can be substantially similar or different for the exemplary access point and terminal described below. In addition, it is to be appreciated that the access point and/or the terminal can employ the systems (FIGS. 1-3, 7, 8, and 10) and/or methods (FIGS. 4-6) described herein to facilitate wireless communication there between.

Referring now to FIG. 9, on a downlink, at access point 905, a transmit (TX) data processor 910 receives, formats, codes, interleaves, and modulates (or symbol maps) traffic data and provides modulation symbols (“data symbols”). A symbol modulator 915 receives and processes the data symbols and pilot symbols and provides a stream of symbols. A symbol modulator 920 multiplexes data and pilot symbols and provides them to a transmitter unit (TMTR) 920. Each transmit symbol may be a data symbol, a pilot symbol, or a signal value of zero. The pilot symbols may be sent continuously in each symbol period. The pilot symbols can be frequency division multiplexed (FDM), orthogonal frequency division multiplexed (OFDM), time division multiptexed (TDM), frequency division multiplexed (FDSM), or code division multiplexed (CDM).

TMTR 920 receives and converts the stream of symbols into one or more analog signals and further conditions (e.g. amplifies, filters, and frequency upconverts) the analog signals to generate a downlink signal suitable for transmission over the wireless channel. The downlink signal is then transmitted through an antenna 925 to the terminals. At terminal 930, an antenna 935 receives the downlink signal and provides a received signal to a receiver unit (RCVP) 940. Receiver unit 940 conditions (e.g., filters, amplifies, and frequency downconverts) the received signal and digitizes the conditioned signal to obtain samples. A symbol demodulator 945 demodulates and provides received pilot symbols to a processor 950 for channel estimation. Symbol demodulator 945 further receives a frequency response estimate for the downlink from processor 950, performs data demodulation on the received data symbols to obtain data symbol estimates (which are estimates of the transmitted data symbols), and provides the data symbol estimates to an RX data processor 955, which demodulates (i.e., symbol demaps), deinterleaves, and decodes the data symbol estimates to recover the transmitted traffic data. The processing by symbol demodulator 945 and RX data processor 955 is complementary to the processing by symbol modulator 915 and TX data processor 910, respectively, at access point 905.

On the uplink, a TX data processor 960 processes traffic data and provides data symbols. A symbol modulator 965 receives and multiplexes the data symbols with pilot symbols, performs modulation, and provides a stream of symbols. A transmitter unit 970 then receives and processes the stream of symbols to generate an uplink signal, which is transmitted by the antenna 935 to the access point 905.

At access point 905, the uplink signal from terminal 930 is received by the antenna 925 and processed by a receiver unit 975 to obtain samples. A symbol demodulator 980 then processes the samples and provides received pilot symbols and data symbol estimates for the uplink. An RX data processor 985 processes the data symbol estimates to recover the traffic data transmitted by terminal 930. A processor 990 performs channel estimation for each active terminal transmitting on the uplink. Multiple terminals may transmit pilot concurrently on the uplink on their respective assigned sets of pilot subbands, where the pilot subband sets may be interlaced.

Processors 990 and 950 direct (e.g., control, coordinate, manage, etc.) operation at access point 905 and terminal 930, respectively. Respective processors 990 and 950 can be associated with memory units (not shown) that store program codes and data. Processors 990 and 950 can also perform computations to derive frequency and impulse response estimates for the uplink and downlink, respectively.

For a multiple-access system (e.g., FDMA, OFDMA, CDMA, TDMA, etc.), multiple terminals can transmit concurrently on the uplink. For such a system, the pilot subbands may be shared among different terminals. The channel estimation techniques may be used in cases where the pilot subbands for each terminal span the entire operating band (possibly except for the band edges). Such a pilot subband structure would be desirable to obtain frequency diversity for each terminal. The techniques described herein may be implemented by various means. For example, these techniques may be implemented in hardware, software, or a combination thereof. For a hardware implementation, the processing units used or channel estimation may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a conbination thereof. With software, implementation can be through modules (e.g., procedures, functions, and so on) that perform the functions described herein. The software codes may be stored in memory unit and executed by the processors 990 and 950.

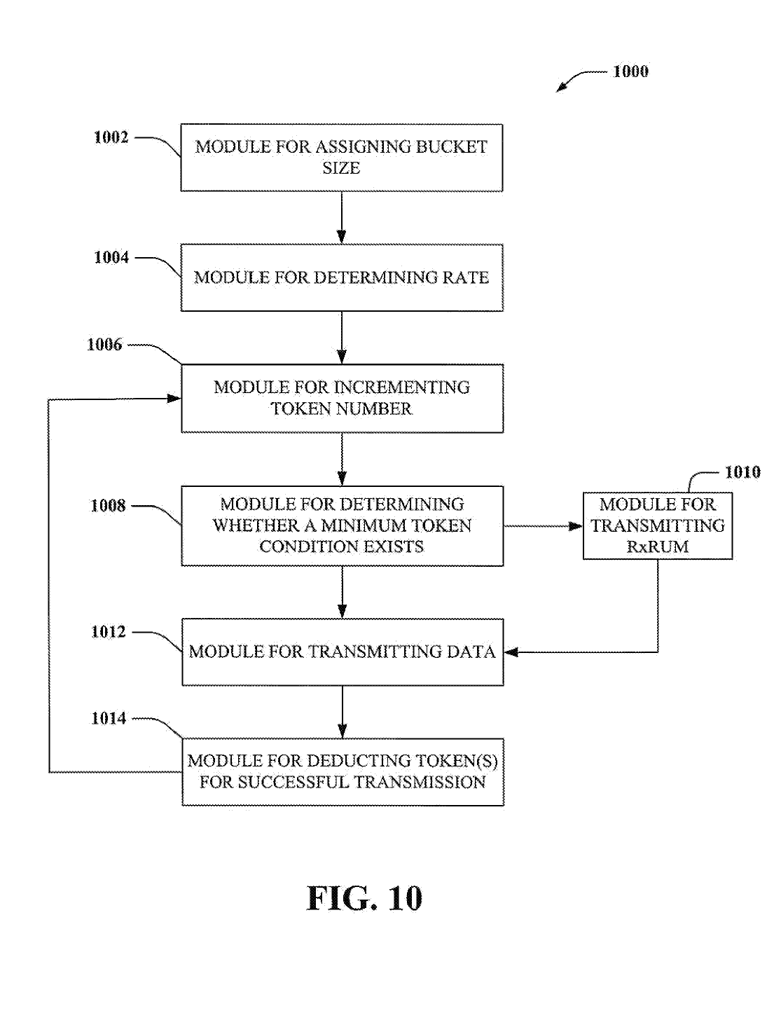

FIG. 10 is an illustration of an apparatus 1000 that facilitates guaranteeing a minimum transmission rate on wireless channels by employing resources utilization messages (RUMs), in accordance with various aspects. Apparatus 1000 is represented as a series of interrelated functional blocks, which can represent functions implemented by a processor, software, or combination thereof (e.g., firmware). For example, apparatus 1000 may provide a modules for performing various acts such as are described above. Apparatus 1000 facilitates providing minimum transmission rate guarantees to users while improving throughput by efficient spatial reuse, and may be employed in, for example, a synchronous ad hoc medium access channel (MAC) or the like. For instance, a token mechanism may be employed to control an amount of RxRUM that a given node may send out. The token mechanism may limit a share of resources that the node may occupy during periods of congestion (e.g., periods of high activity in a wireless communication environment). To control carrier-to-interference ratio (C/I), RxRUMs may thus be transmitted by a receiver, while the rate and quantity of such may be governed by a “token bucket” mechanism. During periods of congestion, nodes share resources fairy according to their respective token generation rates, while at other times excess traffic may be apportioned differently to enhance sector throughput.

Apparatus 1000 comprises a module for assigning a token “bucket” size 1002 for a node (e.g., a receiver, . . . ), which limits the amount of traffic that the node may burst on to the network. A module for determining transmission rate 1004 may determine or assign a token generations rate to the node according to a plurality of factors that may include, without being limited to, node topology, node priority (e.g., weight, . . . ), a number and type of active flows through the node, etc. Module for incrementing token number 1006 may assess a number of tokens in the node's bucket. Additionally, a module for determining whether a minimum token condition exists 1008 can assess whether the number of tokens in the node's bucket is a minimum number, which may be zero or any other predefined minimum number (e.g., 1, 2, 4 . . . ). If the number of tokens in the nodes bucket is equal to or greater than the minimum number, then a module for transmitting an RxRUM 1010 may generate and transmit an RxRUM, which may be followed by a data transmission. If the number of tokens in the node's bucket is less than or equal to the minimum, then means for transmitting data 1012 may still be employed to permit data transmission as normal, but without the an RxRUM. A module for deducting tokens 1014 from the token bucket may then be employed to deduct a number of tokens proportional to the amount of data transmitted, from the node's bucket, upon a successful data transmission by the module for transmitting data 1012. Tokens thus provide a mechanism for controlling resources during transmission congestion, and, while they may be deducted from the bucket upon successful transmission(s), the bucket need only be emptied down to zero (e.g., the bucket has a non-negative value). In this manner apparatus 1000 facilitates improving throughput and spatial reuse between sending and receiving nodes.

For a software implementation, the techniques described herein may be implemented with modules (e.g., procedures, functions, and so on) that perform the functions described herein. The software codes may be stored in memory units and executed by processors The memory unit may be implemented within the processor or external to the processor, in which case it can be communicatively coupled to the processor via various means as is known in the art.

What has been described above includes examples of one or more aspects. It is, of course, not possible to describe every conceivable combination of components or methodologies for purposes of describing the aforementioned aspects, but one of ordinary skill in the art may recognize that may further combinations and permutations of various aspects are possible. Accordingly, the described aspects are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of facilitating data transmission, comprising:
assigning tokens to a node as a function of a token rate associated with the node;
determining whether a number of tokens assigned to the node is equal to or greater than a predefined minimum number of tokens; and
transmitting at least one resource utilization message (RUM) based on the determination.

2. The method of claim 1, wherein a maximum number of tokens assignable to the node is defined, and further wherein assigning comprises assigning tokens to the node as a function of the token rate and the maximum token number.

3. The method of claim 1, further comprising permitting data transmission without a RUM if the number of assigned tokens is less than the predefined minimum number of tokens.

4. The method of claim 3, further comprising deducting a number of tokens from the assigned tokens, wherein the token deduction is based on an amount of data transmitted if the transmission of such data is successful.

5. The method of claim 4, further comprising re-determining a number of tokens assigned the node after the token deduction and transmitting a RUM based on the re-determination.

6. The method of claim 1, wherein the token rate is determined based on at least one of one or more weights assigned to the node, a number of active flows through the node and a type of active flows through the node.

7. The method of claim 6, wherein the one or more weights is a function of throughput at the node.

8. The method of claim 6, wherein an active flow is at least one of an incoming data transmission and an outgoing data transmission.

9. The method of claim 2, further comprising setting the predefined minimum number of tokens to a number less than or equal to the maximum token number.

10. The method of claim 1, wherein the number of tokens assigned to the node is a non-negative number.

11. The method of claim 1, further comprising assigning virtual tokens to temporarily increase a number of RUMs to be transmitted by the node.

12. An apparatus that facilitates data transmission, comprising:
a token module that assigns tokens to a node as a function of a token rate associated with the node and determines whether a number of tokens assigned to the node is equal to or greater than a predefined minimum number of tokens; and
a transmitter that transmits at least one resource utilization message (RUM) based on the determination.

13. The apparatus of claim 12, wherein a maximum number of tokens assignable to the node is defined and further wherein the token module assigns tokens to the node as a function of the token rate and the maximum token number.

14. The apparatus of claim 12, wherein the token module permits data transmission without a RUM if a current number of assigned tokens is below a predefined minimum token number.

15. The apparatus of claim 14, wherein the token module deducts a number of tokens from the assigned tokens, wherein the token deduction is based on an amount of data transmitted if the transmission of such data is successful.

16. The apparatus of claim 15, wherein the token module re-determines a number of tokens assigned to the node after the token deduction and transmits a RUM based on the re-determination.

17. The apparatus of claim 12, wherein the token rate is determined based on at least one of one or more weights assigned to the node, a number of active flows through the node and a type of active flows through the node.

18. The apparatus of claim 17, wherein the one or more weights is a function of throughput at the node.

19. The apparatus of claim 17, wherein an active flow is at least one of an incoming data transmission and an outgoing data transmission.

20. The apparatus of claim 13, wherein the token module sets the predefined minimum number of tokens to a number less than or equal to the maximum token number.

21. The apparatus of claim 12, wherein the number of tokens assigned to the node is a non-negative number.

22. The apparatus of claim 12, wherein the token module assigns virtual tokens to temporarily increase a number of RUMs to be transmitted by the node.

23. The apparatus of claim 12, wherein the apparatus is employed in an access point.

24. The apparatus of claim 12, wherein the apparatus is employed in an access terminal.

25. An apparatus that facilitates data transmission, comprising:
means for assigning tokens to a node as a function of a token rate associated with the node;
means for determining whether a number of tokens assigned to the node is equal to or greater than a predefined minimum number of tokens; and
means for transmitting at least one resource utilization message (RUM) based on the determination.

26. The apparatus of claim 25, wherein a maximum number of tokens assignable to the node is defined, and further wherein the assigning means assigns tokens to the node as a function of the token rate an the maximum token number.

27. The apparatus of claim 25, further comprising means for permitting data transmission without a RUM if the number of assigned tokens is less than the predefined minimum number of tokens.

28. The apparatus of claim 27, further comprising means for deducting a number of tokens from the assigned tokens, wherein the token deduction is based on an amount of data transmitted if the transmission of such data is successful.

29. The apparatus of claim 28, wherein the determining means re-determines a number of tokens assigned to the node after the token deduction and transmitting a RUM based on the re-determination.

30. The apparatus of claim 25, wherein the token rate is determined based on at least one of one or more weights assigned to the node, a number of active flows through the node and a type of active flows through the node.

31. The apparatus of claim 30, wherein the one or more weights is a function of throughput at the node.

32. The apparatus of claim 30, wherein an active flow is at least one of an incoming data transmission and an outgoing data transmission.

33. The apparatus of claim 26, further comprising means for setting the predefined minimum number of tokens to a number less than or equal to the maximum token number.

34. The apparatus of claim 25, wherein the number of tokens assigned to the node is a non-negative number.

35. The apparatus of claim 25, wherein the assigning means further assigns virtual tokens to temporarily increase a number of RUMs to be transmitted by the node.

36. The apparatus of claim 25, wherein the apparatus is employed in an access terminal.

37. The apparatus of claim 25, wherein the apparatus is employed in an access point.

38. A machine-readable medium comprising instructions for data transmission, wherein the instructions upon execution cause the machine to:
assign tokens to a node as a function of a token rate associated with the node;
determine whether a number of tokens assigned to the node is equal to or greater than a predefined minimum number of tokens; and
transmit at least one resource utilization message (RUM) based on the determination.

39. A processor for facilitating data transmission, the processor being configured to:
assign tokens to a node as a function of a token rate associated with the node determine whether a number of tokens assigned to the node is equal to or greater than a predefined minimum number of tokens; and
transmit at least one resource utilization message (RUM) based on the determination.
